(19) United States
(12) Patent Application Publication
(10) Pub. No.: US 2026/0202638 A1
(43) Pub. Date: Jul. 16, 2026

(54) ACCESSORY APPARATUS

(71) Applicant: CANON KABUSHIKI KAISHA, Tokyo (JP)

(72) Inventor: YUMIKO SHINOZUKA, Kanagawa (JP)

(21) Appl. No.: 19/437,069

(22) Filed: Dec. 30, 2025

(30) Foreign Application Priority Data
Jan. 10, 2025 (JP) 2025-003834

(51) Int. Cl. G02B 7/10; G02B 7/08; G03B 17/18; H04N 23/66; H04N 23/69

(52) U.S. Cl. CPC G02B 7/102; G02B 7/08; G03B 17/18; H04N 23/66; H04N 23/69; G03B 2205/0046; G03B 2206/002

(57) ABSTRACT

Accessory apparatuses, control methos, and storage media are provided herein. One or more accessory apparatuses may be attachable to and detachable from an image pickup apparatus, and include an operation member operable by a user at a plurality of operation amounts in a first direction, one or more memories storing instructions, and one or more processors that, upon execution of the instructions, operate to control moving of an optical member via a drive unit according to the operation amounts, and determine a moving speed of the optical member for each of the plurality of operation amounts based on speed information on a speed selected in the image pickup apparatus.

### BACKGROUND

### Field of the Technology

The aspect of the embodiments relates to one or more embodiments of an accessory apparatus, such as a lens apparatus attachable to an image pickup apparatus.

### Description of the Related Art

Some image pickup apparatuses, such as digital cameras and video cameras, have an operation member, such as a seesaw switch, which is operable by a user to drive an optical member, such as a zoom lens. Japanese Patent Application Laid-Open No. 2020-043498 discloses an image pickup apparatus configured to set a plurality of zoom speeds for a plurality of operation amounts of the seesaw switch.

### SUMMARY

One or more embodiments of an accessory apparatus according to one or more aspects of the disclosure may be attachable to and detachable from an image pickup apparatus, and include an operation member operable by a user at a plurality of operation amounts in a first direction, one or more memories storing instructions, and one or more processors that, upon execution of the instructions, operate to control moving of an optical member via a drive unit according to the operation amounts, and determine a moving speed of the optical member for each of the plurality of operation amounts based on speed information on a speed selected in the image pickup apparatus. One or more embodiments of an accessory apparatus according to one or more aspects of the disclosure may be attachable to and detachable from an image pickup apparatus, and include an operation member that is operable, one or more memories storing instructions, and one or more processors that, upon execution of the instructions, operate to control moving of the optical member via a drive unit according to an operation amount of the operation member, and determine a moving speed of an optical member based on the operation amount and speed information on a plurality of speeds selected in the image pickup apparatus. One or more control methods corresponding to the above one or more control apparatuses also constitutes another aspect of the disclosure. A storage medium storing a program that causes a computer to execute the above one or more control methods also constitutes another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating the configurations of an interchangeable lens and a camera body in a first embodiment.

FIG. 2 illustrates a zoom operation ring in the first embodiment.

FIG. 3 illustrates a zoom-speed change menu in the first embodiment.

FIGS. 4A and 4B illustrate examples of zoom speed tables in the first embodiment.

FIG. 5 is a block diagram illustrating the configuration of a lens microcomputer in the first embodiment.

FIG. 6 is a flowchart illustrating processing in the first embodiment.

FIG. 7 is a flowchart illustrating processing in a second embodiment.

FIG. 8 illustrates a relationship among the number of steps (step number) of the zoom operation ring and the zoom speed in the second embodiment.

FIG. 9 is a flowchart illustrating processing in a third embodiment.

FIG. 10 is a flowchart illustrating processing in a fourth embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a description will be given of embodiments according to the disclosure.

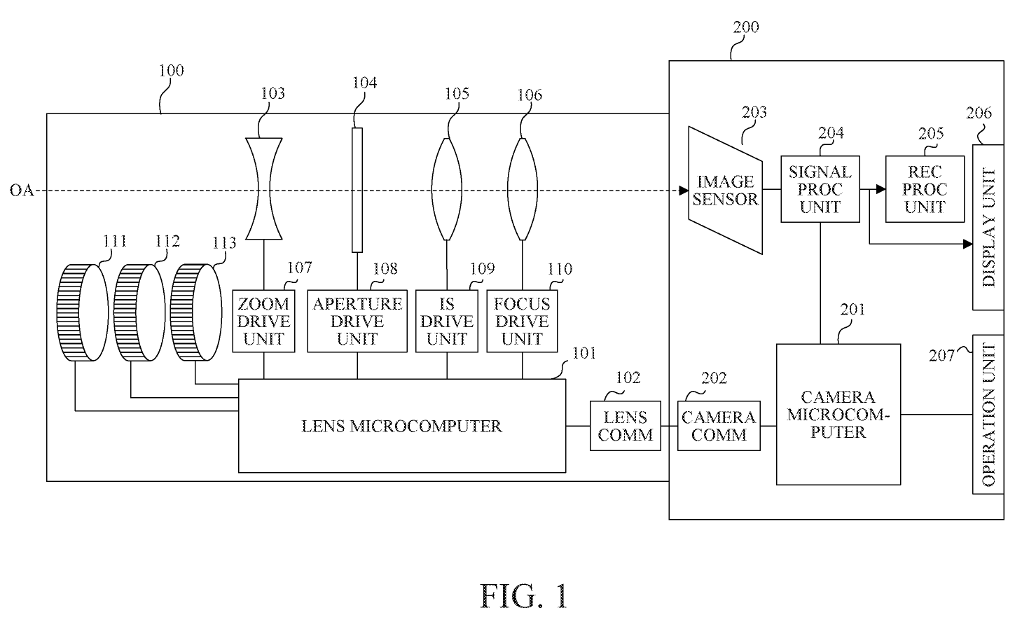

FIG. 1 illustrates the configuration of an interchangeable lens (lens apparatus) 100 as an accessory apparatus according to the embodiment, and a camera body 200 as an image pickup apparatus. The interchangeable lens 100 is attachable to and detachable from the camera body 200.

The interchangeable lens 100 is mechanically and electrically connected to the camera body 200 via a mount (not illustrated). The interchangeable lens 100 receives power from the camera body 200 via a power terminal (not illustrated) provided on the mount. A lens microcomputer 101 operates using the supplied power and communicates with the camera body 200 via a communication terminal provided on the mount and a lens communication unit (lens COMM) 102. The lens microcomputer 101 includes a CPU (one or more processors) and one or more memories such as RAM, ROM, and EEPROM, and sends and receives ID information to and from the camera body 200, and controls various actuators (described below) in response to control commands received from the camera body 200. The one or more memories store instructions, and the CPU that, upon execution of the instructions, operates to control the driving of the optical member (moving of the optical member via the drive unit according to the operation amounts), which will be described later, and determine a moving speed of the optical member for each of the operation amounts. The one or more memories may further store other data, such as data on a drive speed corresponding to speed information on a speed selected in the camera body 200.

The interchangeable lens 100 includes an imaging optical system. The imaging optical system includes optical members such as a zoom lens 103, an aperture stop unit 104, an image stabilizing lens 105, and a focus lens 106. The interchangeable lens 100 further includes drive units such as a zoom drive unit 107, an aperture drive unit 108, an image-stabilizing (IS) drive unit 109, and a focus drive unit 110.

Zooming (magnification variation) of the imaging optical system can be achieved by moving the zoom lens 103 in the optical axis direction, which is a direction in which the optical axis OA, indicated by a broken line in FIG. 1, extends. The lens microcomputer 101 detects the position of the zoom lens 103 via a zoom position sensor such as a photo-interrupter (not illustrated). The zoom drive unit 107 outputs a zoom drive signal in response to commands from the lens microcomputer 101, and moves the zoom lens 103 by driving a zoom actuator such as a stepping motor or vibration motor.

The aperture stop unit 104 adjusts a light amount in the imaging optical system by opening and closing aperture blades (not illustrated). The lens microcomputer 101 detects the positions of the aperture blades through an aperture position sensor such as a Hall element (not illustrated). The aperture drive unit 108 outputs an aperture drive signal in response to commands from the lens microcomputer 101 to drive an aperture actuator such as a stepping motor, thereby operating the aperture stop unit 104.

The image stabilizing lens 105 reduces image blur caused by camera shake or the like by moving (shifting) in a direction (having a component) orthogonal to the optical axis OA. The image-stabilizing drive unit 109 outputs a shift drive signal according to commands from the lens microcomputer 101 and camera shake detected by a shake sensor such as a vibration gyroscope (not illustrated), thereby driving an image stabilizing actuator such as a voice coil motor, and shifting the image stabilizing lens 105.

The focus lens 106 is movable in the optical axis direction, enabling focusing of the imaging optical system. The lens microcomputer 101 detects the position of the focus lens 106 through a focus-position sensor such as a photo-interrupter (not illustrated). The focus drive unit 110 outputs a focus drive signal according to commands from the lens microcomputer 101 to drive a focus actuator such as a stepping motor or vibration motor, thereby moving the focus lens 106. The focus drive unit 110 also moves the focus lens 106 according to commands from the lens microcomputer 101 so as to correct image-plane fluctuations that occur during zooming due to movement of the zoom lens 103.

The interchangeable lens 100 further includes a zoom operation ring 111, a focus operation ring 112, and an aperture operation ring 113, each of which is an operation member described above. The rotational positions of the zoom operation ring 111, focus operation ring 112, and aperture operation ring 113 are detected by a rotational-position sensor (not illustrated) and input to the lens microcomputer 101. The lens microcomputer 101 controls the zoom drive unit 107, the focus drive unit 110, and the aperture drive unit 108 to drive the zoom lens 103, focus lens 106, and aperture stop unit 104 in accordance with the detected rotational positions of the zoom, focus, and aperture operation rings 111, 112, and 113.

The camera body 200 includes a camera microcomputer 201, a camera communication unit (camera COMM) 202, an image sensor 203, a signal processing unit 204, a recording processing unit (REC proc unit) 205, a display unit 206, and an operation unit 207. The camera microcomputer 201 includes a CPU and memories such as RAM, ROM, and EEPROM, and controls the camera body 200 and the interchangeable lens 100. The camera communication unit 202 enables communication between the lens microcomputer 101 and the camera microcomputer 201 via a communication terminal provided on the mount and the lens communication unit 102 of the interchangeable lens 100. The camera microcomputer 201 sends and receives ID information to the lens microcomputer 101, and sends control commands to the lens microcomputer 101.

The camera microcomputer 201 also accepts inputs according to the operation of various operation members included in the operation unit 207, such as an imaging switch, an aperture-value setting dial, a shutter-speed setting dial, a zoom setting lever, a cross key, and a setting button, and performs control and processing according to the inputs.

The image sensor 203 photoelectrically converts (captures) an object image formed by the imaging optical system and outputs an analog signal. The analog signal is converted into a digital signal by an A/D converter (not illustrated).

The signal processing unit 204 performs various image processing on the digital signal from the A/D converter to generate a video signal. The signal processing unit 204 also generates defocus information for autofocus (AF) and luminance information for exposure control from the video signal. The signal processing unit 204 outputs the generated video signal to the display unit 206. The video signal is displayed as a live-view image used to check the composition, focus, and other parameters. The signal processing unit 204 outputs the video signal to the recording processing unit 205. The recording processing unit 205 stores the video signal in an external memory as still or moving image data.

### FIRST EMBODIMENT

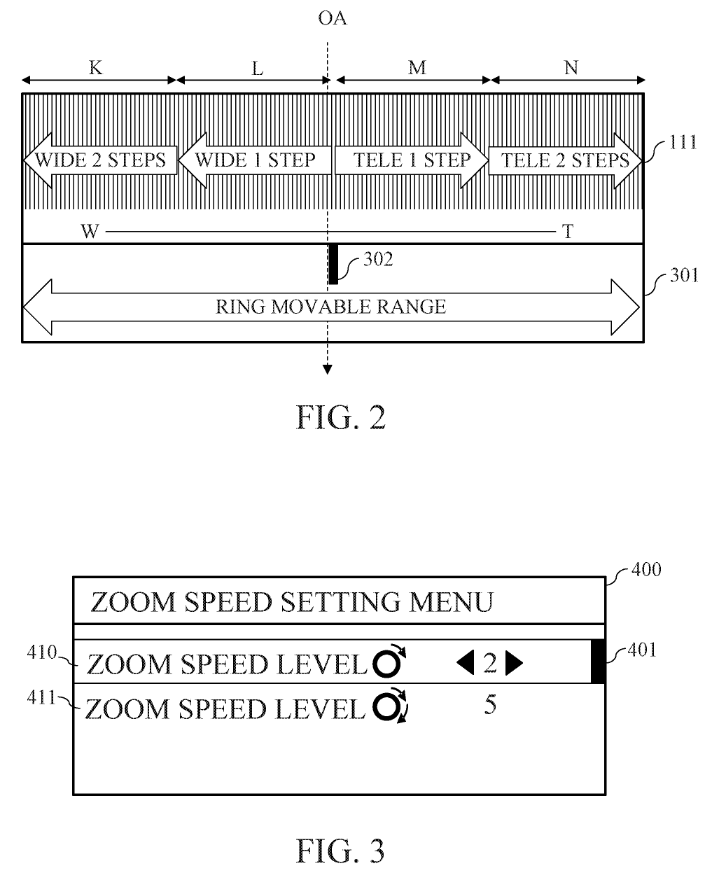

A first embodiment will be described with reference to FIGS. 2 to 5. FIG. 2 illustrates the zoom operation ring 111 developed around the optical axis OA, which is its rotational center axis. The zoom operation ring 111 is rotatably mounted on the outer circumference of an exterior barrel 301 of the interchangeable lens 100 around the optical axis OA and is rotatable by the user to specify the moving direction and speed (zoom speed) of the zoom lens 103. The exterior barrel 301 includes a mark 302 that serves as an operation indicator for the zoom operation ring 111. The zoom operation ring 111 has a midpoint return mechanism that includes a coil spring or the like, and holds or returns the unoperated zoom operation ring 111 at or to the midpoint of a ring rotatable range as its rotatable range.

The zoom operation ring 111 can be rotated from the midpoint to the W (wide-angle) side or the T (telephoto) side. When the zoom operation ring 111 is rotated from the midpoint to the right in FIG. 2 so that the mark 302 is located on the W side, the lens microcomputer 101 causes the zoom drive unit 107 to drive the zoom lens 103 to the W side at a predetermined zoom speed. In a case where the zoom operation ring 111 is rotated from the midpoint to the left in FIG. 2 so that the mark 302 is located on the T side, the lens microcomputer 101 causes the zoom drive unit 107 to drive the zoom lens 103 to the T side at a predetermined zoom speed.

There are two zoom speeds, and in a case where the rotation operation amount of the zoom operation ring 111 is a first operation amount so that the mark 302 is in an L range on the W side or an M range on the T side, the zoom lens 103 is driven at the first zoom speed. In a case where the rotation operation amount of the zoom operation ring 111 is a second operation amount greater than the first operation amount so that the mark 302 is in a K range on the W side or an N range on the T side, the zoom lens 103 is driven at a second zoom speed faster than the first zoom speed. Thus, this embodiment divides the operation amount in the same operation direction of the zoom operation ring 111 into a plurality of amounts (two in this embodiment), and assigns a different zoom speed to each operation amount.

In this embodiment, the first zoom speed and second zoom speed corresponding to the rotation operation amount of the zoom operation ring 111 can be set (changed) via a zoom-speed setting menu 400 displayed on the display unit 206 of the camera body 200, as illustrated in FIG. 3 . The zoom-speed setting menu 400 has selectable items of a zoom speed level 410 (indicated by a circle indicating a zoom operation ring and one arrow indicating a small operation amount) and a zoom speed level 411 (indicated by a circle and two arrows indicating a large operation amount). The zoom speed level 410 allows the setting of a first zoom speed level for the interchangeable lens 100, and the zoom speed level 411 allows the setting of a second zoom speed level for the interchangeable lens 100.

The zoom speed level 410 is selected by operating the up/down portions on the cross key of the operation unit 207 (reference numeral 401 denotes the selected state), and the level value (2 in FIG. 3) is displayed by operating the left/right portions on the cross key. The first zoom speed level is set to that level value by operating the setting button. After the zoom speed level 411 is selected, the level value (5 in FIG. 3) is displayed. The second zoom speed level is set to that level value by operating the setting button. Here, the level values from 1 to 5 can be set, and the higher the level value is, the faster the zoom speed is. However, the number of level values and the relationship between the level values and the zoom speed are not limited to this example. The first and second zoom speeds may also be set by speed values (e.g., mm/sec) rather than speed levels. In other words, the zoom-speed setting information may be information on the zoom speed selected by the user.

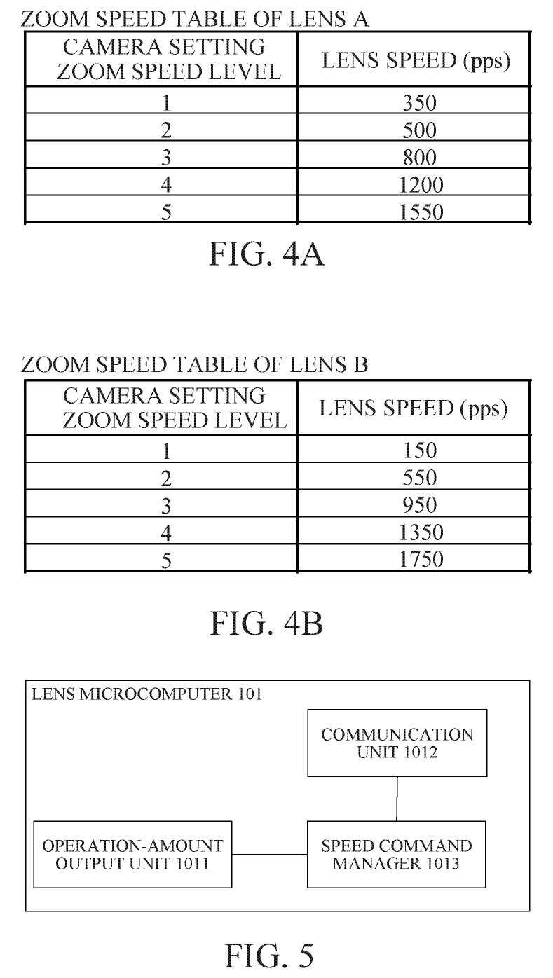

Thus, the zoom speed set in the interchangeable lens 100 relative to the zoom speed level set in the camera body 200 differs for each model of the interchangeable lens. FIGS. 4A and 4B illustrate a relationship (zoom speed table) between the zoom speed levels set in camera body 200 and the zoom speeds of interchangeable lenses A and B, which are different models. For the interchangeable lens A illustrated in FIG. 4A, zoom speeds of 350, 500, 800, 1200, and 1550 pps (pulses per second) are set for the zoom speed levels "1" to "5" set in the camera body 200. On the other hand, for the interchangeable lens B illustrated in FIG. 4B, unlike the interchangeable lens A, zoom speeds of 150, 550, 950, 1350, and 1750 pps are set for the zoom speed levels "1" to "5" set in the camera body 200.

The reason the zoom speeds for the zoom speed levels set in the camera body 200 differ for each model of the interchangeable lens is due to differences in the mass of zoom lens 103 and the type of zoom actuator for each interchangeable lens model. The zoom speed tables illustrated in FIGS. 4A and 4B are stored in the speed command manager (described later) within the lens microcomputer 101 of each of interchangeable lenses A and B.

The camera microcomputer 201 generates zoom-speed setting information as speed information indicating the first and second zoom speed levels in the zoom-speed setting menu 400, and sends the zoom speed setting information to the lens microcomputer 101.

FIG. 5 illustrates the configuration of the lens microcomputer 101. The lens microcomputer 101 includes an operation-amount output unit 1011, a communication unit 1012, and a speed command manager 1013.

The operation-amount output unit 1011 converts the position signal of the zoom operation ring 111 from the rotation position sensor described above into zoom operation direction information and zoom operation amount information. The zoom operation direction information is information that indicates the W direction and T direction, which are the rotation operation directions (zoom directions) of the zoom operation ring 111. The zoom operation amount information indicates whether the operation amount of the zoom operation ring 111 is in the range of L or M (first operation amount) or the range of K or N (second operation amount) illustrated in FIG. 2. The drive direction information and operation amount information are output to the speed command manager 1013. In a case where the information received from the camera microcomputer 201 via the lens communication unit 102 is zoom speed setting information, the communication unit 1012 outputs the zoom speed setting information to the speed command manager 1013.

The speed command manager 1013 outputs a zoom instruction (zoom drive signal) to drive the zoom lens 103 to the zoom drive unit 107 based on the input zoom operation direction information, zoom operation amount information, zoom speed setting information, and the stored zoom speed table. More specifically, it outputs a zoom command to the zoom drive unit 107 to drive the zoom lens 103 in the zoom direction indicated by the zoom operation direction information at a zoom speed corresponding to the zoom speed level indicated by the zoom speed setting information and the operation amount indicated by the zoom operation amount information in the zoom speed table. In a case where new zoom speed setting information is input in accordance with a change in the zoom speed level in the camera body 200 after the zoom command is output, the speed command manager 1013 changes the zoom drive signal to correspond to the new zoom speed setting information and zoom operation amount information in the zoom speed table.

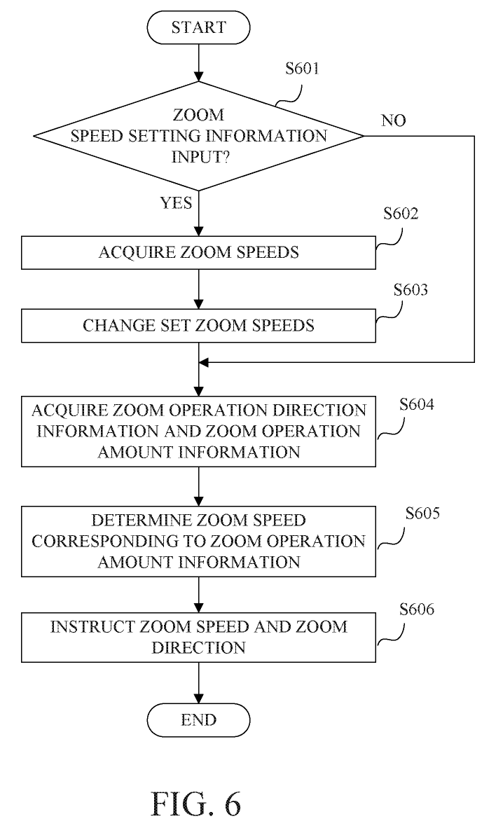

A flowchart in FIG. 6 illustrates processing (a control method) in which, in a case where the speed command manager 1013 determines that zoom speed setting information has been input from the communication unit 1012, it acquires zoom operation direction information and zoom operation amount information and outputs a zoom instruction to the zoom drive unit 107. The speed command manager 1013 in the lens microcomputer 101 executes this processing in accordance with a program. S stands for the step.

In S601, the speed command manager 1013 determines whether zoom speed setting information (first and second zoom speed levels) has been input from the communication unit 1012. In a case where it has been input, it performs processing in S602; in a case where it has not been input, it performs processing in S604.

In S602, the speed command manager 1013 acquires, from the zoom speed table, first and second zoom speeds that correspond to the first and second zoom speed levels indicated by the zoom speed setting information.

Next, in S603, the speed command manager 1013 changes the first and second zoom speeds from the currently set first and second zoom speeds to the first and second zoom speeds acquired in S602.

In S604, the speed command manager 1013 acquires zoom operation direction information and zoom operation amount information from the operation-amount output unit 1011.

Next, in S605, the speed command manager 1013 determines, as the zoom speed to be instructed, the zoom speed that corresponds to the operation amount (first or second operation amount) indicated by the zoom operation amount information, among the first and second zoom speeds changed in S603.

Next, in S606, the speed command manager 1013 outputs a zoom command to the zoom drive unit 107, including the zoom speed determined in S605 and the zoom direction indicated by the zoom operation direction information. This flow then ends.

According to this embodiment, the interchangeable lens 100 can change (determine) the zoom speed set for the operation amount of the zoom operation ring 111 based on the zoom speed setting information received from the camera body 200. This allows the user to set the zoom speed relative to the operation amount of the zoom operation ring 111 according to the user’s preference and an imaging situation.

In this embodiment, the zoom speeds for the two operation amounts of the zoom operation ring 111 may be set from the camera body 200, but the operation amount of the zoom operation ring can be divided into three or more, and the zoom speeds for these three or more operation amounts may be set from the camera body 200.

In this embodiment, the zoom speeds corresponding to the operation amounts on the W and T sides, which are the operation directions of the zoom operation ring 111, are set to be the same, but these zoom speeds may also be set to be different.

In this embodiment, the zoom speed corresponding to the operation amount of the zoom operation ring 111 is set, but the zoom speed corresponding to the operation amount of another operation member such as a two-stage switch or a seesaw switch may also be similarly set.

In this embodiment, the zoom speed corresponding to the operation amount of the zoom operation ring 111 is set, but the drive speed of an optical member such as the focus lens 106 and aperture stop unit 104 may also be similarly set for the operation amount of another operation member such as the focus operation ring 112 and aperture operation ring 113.

### SECOND EMBODIMENT

A second embodiment can set (change) two zoom speed levels, first and second zoom speed levels, in the camera body 200, and divide the operation amount for each of the W and T sides of the zoom operation ring 111 of the interchangeable lens 100 into five, first to fifth operation amounts. Those elements in this embodiment, which are corresponding elements in the first embodiment, will be designated by the same reference numerals as those in the first embodiment.

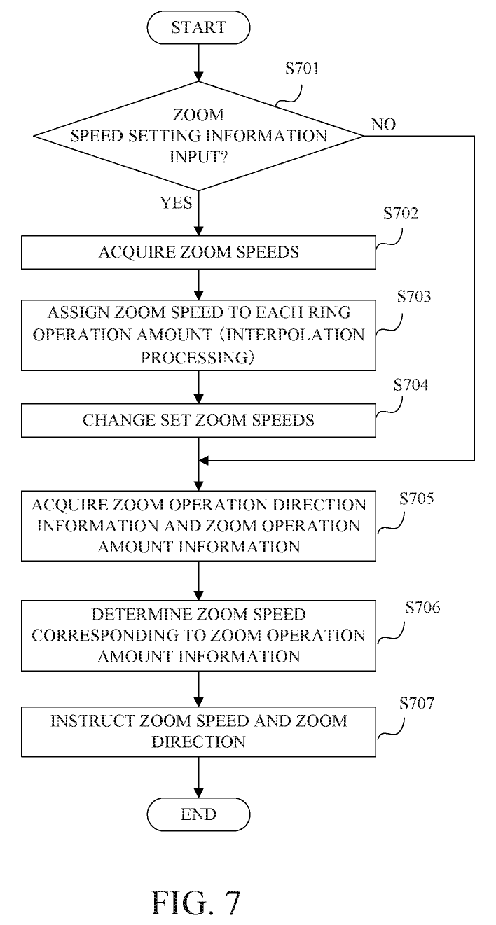

A flowchart in FIG. 7 illustrates processing for acquiring zoom operation direction information and zoom operation amount information and outputting a zoom command to the zoom drive unit 107 in a case where the speed command manager 1013 determines that zoom speed setting information has been input from the communication unit 1012.

In S701, the speed command manager 1013 determines whether zoom speed setting information (first and second zoom speed levels) has been input from the communication unit 1012. In a case where it has been input, it performs the processing of S702, and in a case where it has not been input, it performs the processing of S705.

In S702, the speed command manager 1013 acquires, from the zoom speed table, the first and fifth zoom speeds corresponding to the first and second zoom speed levels indicated by the zoom speed setting information.

Next, in S703, the speed command manager 1013 assigns the five zoom speeds to the first to fifth operation amounts of the zoom operation ring 111. The first operation amount is the smallest of the first to fifth operation amounts, and the fifth operation amount is the largest. The second to fourth operation amounts increase in this order. The speed command manager 1013 assigns the first zoom speed to the first operation amount and the fifth zoom speed to the fifth operation amount. The speed command manager 1013 calculates three speeds, i.e., the second, third, and fourth zoom speeds, by interpolation processing using the first and second zoom speeds, and assigns these second, third, and third zoom speeds to the second, third, and fourth operation amounts in order of decreasing speed. Details of the interpolation processing will be described later.

Next, in S704, the speed command manager 1013 changes the first to fifth zoom speeds currently set for the first to fifth operation amounts to the first to fifth zoom speeds acquired in S703.

Next, in S705, the speed command manager 1013 acquires zoom operation direction information and zoom operation amount information from the operation-amount output unit 1011.

Next, in S706, the speed command manager 1013 determines, as the zoom speed to be instructed, the zoom speed among the first to fifth zoom speeds changed in S704 that corresponds to the operation amount indicated by the zoom operation amount information.

Next, in S707, the speed command manager 1013 outputs a zoom command including the zoom speed determined in S706 and the zoom direction indicated by the zoom operation direction information to the zoom drive unit 107. This flow then ends.

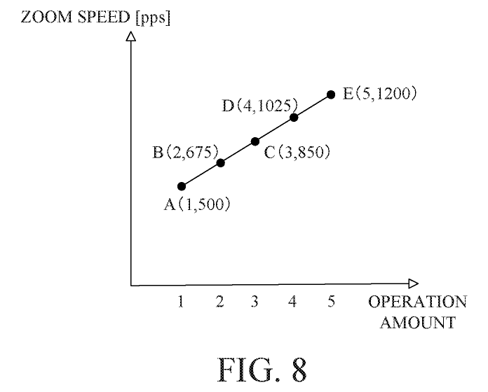

FIG. 8 illustrates interpolation processing performed by the speed command manager 1013 in S703. Here, it is assumed that the speed command manager 1013 stores the zoom speed table illustrated in FIG. 4A. In a case where the speed command manager 1013 receives "2" as the first zoom speed level and "4" as the second zoom speed level from the camera microcomputer 201, the speed command manager 1013 determines 500 pps as the first zoom speed and 1200 pps as the fifth zoom speed in the zoom speed table.

The horizontal axis in FIG. 8 represents the first to fifth operation amounts of the zoom operation ring 111, and the vertical axis represents the set zoom speed. Interpolation processing uses A (1,500) and E (5,1200), which indicate (operation amount, zoom speed (pps)), as the minimum and maximum zoom speeds, and calculates B (2,675), C (3,850), and D (4,1025) between them by linear interpolation. That is, it calculates 675 pps as the second zoom speed, 850 pps as the third zoom speed, and 1025 pps as the fourth zoom speed.

In a case where the camera microcomputer 201 receives a first zoom speed level of "1" and a second zoom speed level of "5," the speed command manager 1013 determines 350 pps in the zoom speed table as the first zoom speed and 1550 pps as the fifth zoom speed. Furthermore, it calculates B (2,650), C (3,950), and D (4,1250) by linear interpolation using A (1,350) and E (5,1550) as the minimum and maximum zoom speeds. That is, it calculates 650 pps as the second zoom speed, 950 pps as the third zoom speed, and 1250 pps as the fourth zoom speed. These second to fourth zoom speeds are different from the zoom speeds corresponding to zoom speed levels "2" to "4" in the zoom speed table of FIG. 4A.

Nonlinear interpolation may be performed in the interpolation processing, or the zoom speeds corresponding to the first and second zoom speed levels may be used as zoom speeds other than the minimum and maximum zoom speeds.

According to this embodiment, even if the number of divisions (five) of the operation amount of the zoom operation ring 111 is greater than the number of zoom speed levels (two) that can be set in the camera body 200, the zoom speed for each operation amount can be properly changed (determined). The user can then set the zoom speed for the operation amount of the zoom operation ring 111 according to the user’s preference and the imaging situation.

The number of divisions of the operation amount of the zoom operation ring may be any number other than five, as long as it is three or more.

### THIRD EMBODIMENT

A third embodiment will discuss a processing example that can set (change) two zoom speed levels in the camera body 200, and be applicable regardless of the division number of the operation amount of the zoom operation ring 111 of the interchangeable lens 100. Those elements in this embodiment, which are corresponding elements in the first embodiment, will be designated by the same reference numerals as those in the first embodiment.

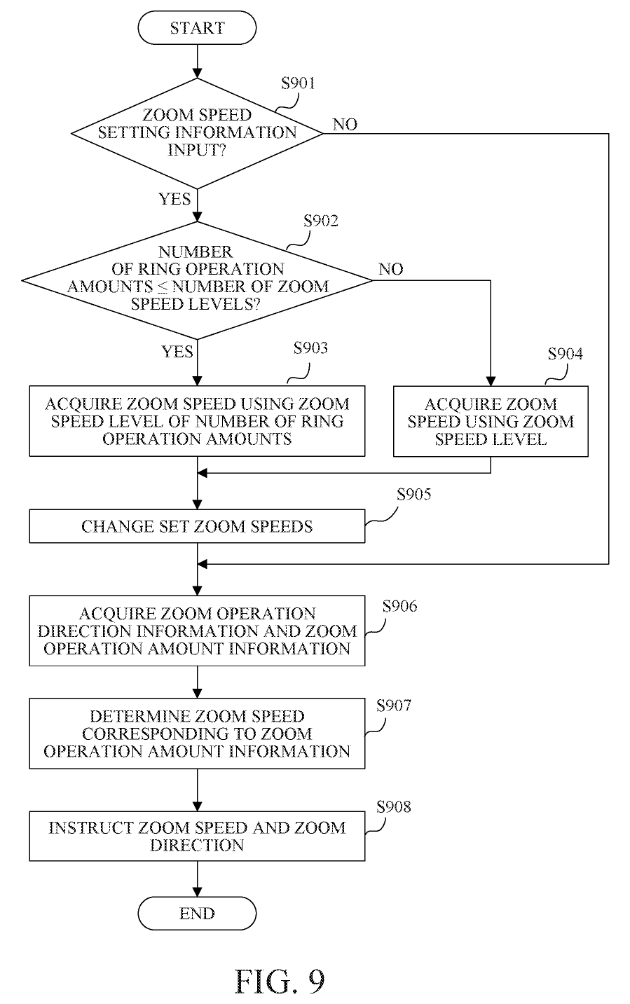

A flowchart in FIG. 9 illustrates processing in which, in a case where the speed command manager 1013 determines that zoom speed setting information has been input from the communication unit 1012, the speed command manager 1013 acquires zoom operation direction information and zoom operation amount information and outputs a zoom command to the zoom drive unit 107.

In S901, the speed command manager 1013 determines whether zoom speed setting information (first and second zoom speed levels) has been input from the communication unit 1012. In a case where it has been input, the processing of S902 is performed; in a case where it has not been input, the processing of S906 is performed.

In S902, the speed command manager 1013 determines whether the number of divisions of the operation amount of the zoom operation ring 111 is equal to or less than the number of zoom speed levels indicated by the zoom speed setting information. In a case where the number of divisions of the operation amount is equal to or less than the number of zoom speed levels, processing of S903 is performed; in a case where the number of divisions of the operation amount is greater than the number of zoom speed levels, processing of S904 is performed.

In S903, the speed command manager 1013 selects zoom speed levels in the same number as the number of divisions of the operation amount from among the zoom speed levels that are equal to or greater than the number of divisions of the operation amount of the zoom operation ring 111 (for example, two) or more (for example, three). The selected zoom speed levels are then assigned to the operation amount of the zoom operation ring 111. At this time, for example, in a case where the order of the three zoom speed levels received from the camera body 200 is the first zoom speed level, the second zoom speed level, and the third zoom speed level, the first zoom speed level may be assigned to the first operation amount and the second zoom speed level may be assigned to the second operation amount, according to that order. Furthermore, when the camera body 200 captures moving images, the first and second zoom speed levels on the slower side of the first to third zoom speed levels may be assigned to the first and second operation amounts, respectively. Furthermore, when the camera body captures still images, the second and third zoom speed levels on the faster side of the first to third zoom speed levels may be assigned to the first and second operation amounts, respectively. Other methods of assigning zoom speed levels to operation amounts may also be used.

The speed command manager 1013 then acquires the first and second zoom speeds corresponding to the two zoom speed levels assigned as described above from the zoom speed table, and then processing in S905 is performed.

In S904, the speed command manager 1013 acquires the zoom speed for each operation amount using zoom speed levels that are fewer (for example, two) than the division number (for example, five) of the operation amount of the zoom operation ring 111. At this time, as in S702 and S703 of the second embodiment (FIG. 7), the zoom speeds for the five operation amounts may be acquired by interpolation processing using two zoom speed levels, or the zoom speed for each operation amount may be acquired by other processing. Thereafter, the processing of S905 is performed.

Next, in S905, the speed command manager 1013 changes the zoom speed currently set for each operation amount to the zoom speed obtained in S903 or S905.

Next, in S906, the speed command manager 1013 acquires zoom operation direction information and zoom operation amount information from the operation-amount output unit 1011.

Next, in S907, the speed command manager 1013 determines, as the zoom speed to be instructed, the zoom speed that corresponds to the operation amount indicated by the zoom operation amount information, from the zoom speeds changed in S905.

Next, in S908, the speed command manager 1013 outputs a zoom command including the zoom speed determined in S907 and the zoom direction indicated by the zoom operation direction information to the zoom drive unit 107. Then, this flow ends.

According to this embodiment, even if the number of zoom speed levels that can be set on the camera body 200 differs from the number of divisions of the operation amount of the zoom operation ring 111, the zoom speed for each operation amount can be properly changed (determined). The user can then set the zoom speed for the operation amount of the zoom operation ring 111 according to the user’s preference and the imaging situation.

### FOURTH EMBODIMENT

A fourth embodiment will discuss a processing example in which the number of zoom speed levels that can be set (changed) on the camera body 200 is one, and the number of divisions of the operation amount of the zoom operation ring 111 of the interchangeable lens 100 is two or more. Those elements in this embodiment, which are corresponding elements in the first embodiment, will be designated by the same reference numerals as those in the first embodiment.

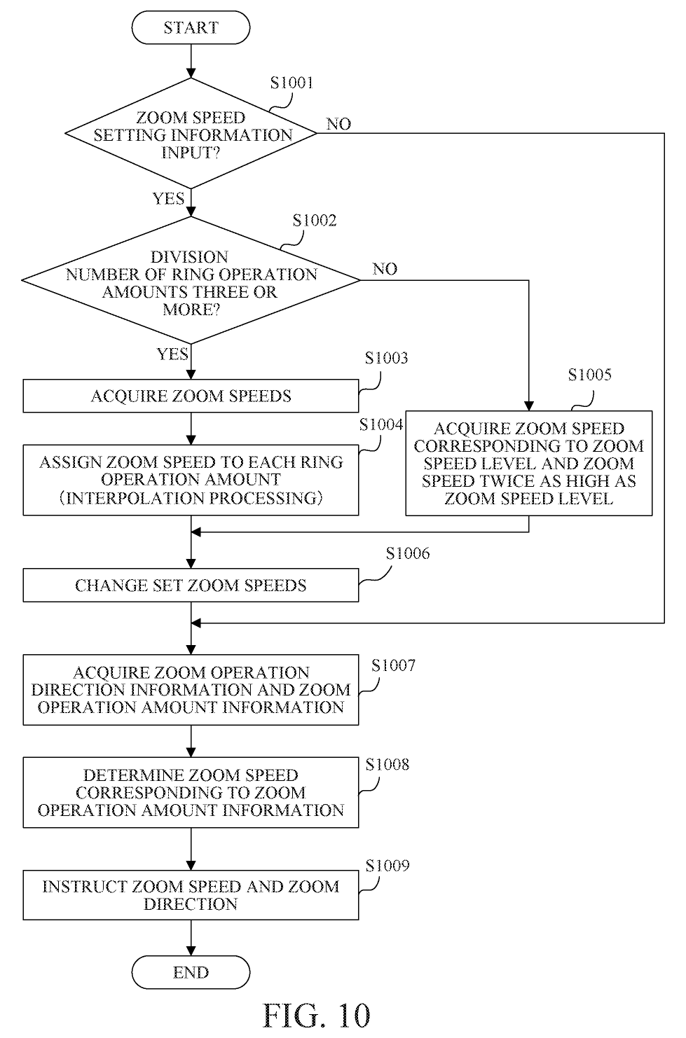

A flowchart in FIG. 10 illustrates processing in which, in a case where the speed command manager 1013 determines that zoom speed setting information has been input from the communication unit 1012, the speed command manager 1013 acquires zoom operation direction information and zoom operation amount information and outputs a zoom command to the zoom drive unit 107.

In S1001, the speed command manager 1013 determines whether zoom speed setting information has been input from the communication unit 1012. In a case where it has been input, the processing of S1002 is performed; in a case where it has not been input, the processing of S1007 is performed.

In S1002, the speed command manager 1013 determines whether the division number of the operation amount of the zoom operation ring 111 is three or more. In a case where the division number is three or more, processing of S1003 is performed; in a case where the division number is less than three, processing of S1005 is performed.

In S1003, the speed command manager 1013 refers to the zoom speed table and acquires the zoom speed corresponding to the zoom speed level (here, "1") indicated by the zoom speed setting information, and the maximum zoom speed of the interchangeable lens 100. In a case where the zoom speed level is "1" and the zoom speed table referenced is the table illustrated in FIG. 4A, the zoom speed corresponding to zoom speed level "1" is 350 pps, and the maximum zoom speed is 1550 pps.

Next, in S1004, the speed command manager 1013 acquires zoom speeds for the three operation amounts of the zoom operation ring 111 using the zoom speed obtained in S1003 and interpolation processing, as in S702 and S703 of the second embodiment (FIG. 7). Then, processing of S1006 is performed.

In S1005, the speed command manager 1013 refers to the zoom speed table and acquires the zoom speed corresponding to zoom speed level "1" indicated by the zoom speed setting information. The speed command manager 1013 further acquires a zoom speed that is a predetermined of number times, such as twice, the zoom speed corresponding to zoom speed level "1" In a case where the zoom speed table to be referenced is the table illustrated in FIG. 4A, the zoom speed corresponding to zoom speed level "1" is 350 pps, and twice that zoom speed is 700 pps. Then, processing of S1006 is performed.

In S1006, the speed command manager 1013 changes the zoom speed currently set for each operation amount to the zoom speed acquired in S1004 or S1005. At this time, the zoom speeds are assigned in order from the smallest operation amount to the largest operation amount in the zoom operation ring 111, starting with the slowest.

Next, in 1007, the speed command manager 1013 acquires zoom operation direction information and zoom operation amount information from the operation-amount output unit 1011.

Next, in S1008, the speed command manager 1013 determines, as the zoom speed to be instructed, the zoom speed that corresponds to the operation amount indicated by the zoom operation amount information, from the zoom speeds changed in S1006.

Next, in S1009, the speed command manager 1013 outputs a zoom command including the zoom speed determined in S1008 and the zoom direction indicated by the zoom operation direction information to the zoom drive unit 107. This flow then ends.

According to this embodiment, even if the number of zoom speed levels that can be set in the camera body 200 is one and the operation amount of the zoom operation ring 111 is divided into two or more, the zoom speed for each operation amount can be properly changed (determined). The user can then set the zoom speed for the operation amount of the zoom operation ring 111 according to the user’s preference and the imaging situation.

In a case where one zoom speed level is other than "1," the zoom speed corresponding to that level may be assigned to an operation amount other than the smallest operation amount of the zoom operation ring 111, and a slower or faster zoom speed may be obtained and assigned to the other operation amounts. In this case, a zoom speed corresponding to one zoom speed level may be assigned to the larger of the two operation amounts of the zoom operation ring 111, and a zoom speed that is a predetermined fraction, such as half, of that zoom speed may be assigned to the smaller operation amount.

According to each embodiment, the zoom speed for each operation amount of the zoom operation ring 111 of the interchangeable lens 100 can be set (changed) from the camera body 200 without changing the firmware of the camera body 200.

In each embodiment, an interchangeable lens is the accessory apparatus, but the accessory apparatus may be something other than an interchangeable lens, such as a drive unit to be attached to the interchangeable lens. The drive unit has a seesaw switch as an operation member, and is configured to drive the lens, etc. within the interchangeable lens by driving the manual operation ring, etc. of the interchangeable lens.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment can easily set a drive speed of an optical member relative to an operation amount of the operation member provided in an accessory apparatus, based on the image pickup apparatus.

This application claims the benefit of Japanese Patent Application No. 2025-003834, filed on January 10, 2025, which is hereby incorporated by reference herein in its entirety.

What is claimed is:

1. An accessory apparatus attachable to and detachable from an image pickup apparatus, the accessory apparatus comprising:
an operation member operable by a user at a plurality of operation amounts in a first direction;
one or more memories storing instructions; and
one or more processors that, upon execution of the instructions, operate to:
control moving of an optical member via a drive unit according to the operation amounts, and
determine a moving speed of the optical member for each of the plurality of operation amounts based on speed information on a speed selected in the image pickup apparatus.

2. The accessory apparatus according to claim 1, wherein the one or more memories store data on the moving speed corresponding to the speed information, and
wherein the one or more processors operate to determine the moving speed for each of the plurality of operation amounts based on the data and the speed information.

3. The accessory apparatus according to claim 1, wherein the speed information indicates a speed level or a speed value selected by a user.

4. The accessory apparatus according to claim 1, wherein in a case where the speed information is information on a plurality of speeds and the number of the plurality of speeds is the same as the number of the plurality of operation amounts, the one or more processors operate to determine the moving speed corresponding to the plurality of speeds for each of the plurality of operation amounts.

5. The accessory apparatus according to claim 1, wherein in a case where the speed information is information on one or more speeds and the number of speeds is less than the number of the plurality of operation amounts, the one or more processors operate to determine the moving speed for each of the plurality of operation amounts using the one or more speeds.

6. The accessory apparatus according to claim 5, wherein the one or more processors operate to determine the moving speed for each of the plurality of operation amounts by performing interpolation processing using the plurality of speeds.

7. The accessory apparatus according to claim 5, wherein the one or more processors operate to determine, for each of the plurality of operation amounts, a drive speed corresponding to one of the one or more speeds and at least one of a predetermined multiple of the one of the one or more speeds and a predetermined fraction of the one of the one or more speeds.

8. The accessory apparatus according to claim 1, wherein in a case where the speed information is information on a plurality of speeds and the number of the plurality of speeds is greater than the number of the plurality of operation amounts, the one or more processors operate to determine the moving speed corresponding to a part of the plurality of speeds for each of the plurality of operation amounts.

9. The accessory apparatus according to claim 1, wherein in a case where the speed information is information on a single speed, the one or more processors operate to determine, for the plurality of operation amounts, a drive speed corresponding to the single speed, a drive speed that is a predetermined multiple of the single speed, and a drive speed that is a predetermined fraction of the single speed.

10. The accessory apparatus according to claim 1, wherein the operation member is operable in a plurality of direction that are different from each other, and
wherein the one or more processors operate to determine the moving speed for each of the plurality of operation amounts in each of the plurality of directions.

11. The accessory apparatus according to claim 10, wherein the one or more processors operate to determine the drive speeds for the plurality of operation amounts in the plurality of directions so that the drive speeds can be equal to each other or different from each other.

12. An accessory apparatus attachable to and detachable from an image pickup apparatus, the accessory apparatus comprising:
an operation member that is operable;
one or more memories storing instructions; and
one or more processors that, upon execution of the instructions, operate to:
control driving of an optical member according to an operation amount of the operation member, and
determine a drive speed of the optical member based on the operation amount and speed information on a plurality of speeds selected in the image pickup apparatus.

13. The accessory apparatus according to claim 12, wherein the operation member outputs a single operation amount, and
wherein the one or more processors operate to:
select one of the plurality of speeds, and
assign the drive speed to the operation amount.

14. The accessory apparatus according to claim 1, wherein the optical member is a zoom lens.

15. The accessory apparatus according to claim 1, wherein the accessory apparatus is a lens apparatus having the optical member.

16. A control method for an accessory apparatus attachable to and detachable from an image pickup apparatus and including an operation member operable by a user in a first direction at a plurality of operation amounts, the control method comprising:
controlling moving of an optical member via a drive unit according to the operation amounts, and
determining a moving speed of the optical member for each of the plurality of operation amounts based on speed information on a speed selected in the image pickup apparatus.

17. A control method for an accessory apparatus attachable to and detachable from an image pickup apparatus and including an operation member that is operable, the control method comprising:
controlling moving of an optical member via a drive unit according to an operation amount of the operation member, and
determining a moving speed of the optical member based on the operation amount and speed information on a plurality of speeds selected in the image pickup apparatus.

18. A non-transitory computer-readable storage medium storing a program that causes a computer to execute the control method according to claim 16.

19. A non-transitory computer-readable storage medium storing a program that causes a computer to execute the control method according to claim 17.
